(19) United States
(12) Patent Application Publication
(10) Pub. No.: US 2016/0223206 A1
(43) Pub. Date: Aug. 4, 2016

(54) Glass ceramic with specially designed surface and method for producing same

(71) Applicant: SCHOTT AG, Mainz (DE)

(72) Inventors: Ralf Bonitz, Stadecken-Elsheim (DE); Edgar Pawlowski, Stadecken-Elsheim (DE); Wolfram Beier, Essenheim (DE)

(73) Assignee: SCHOTT AG, Mainz (DE)

(21) Appl. No.: 15/009,912

(22) Filed: Jan. 29, 2016

(30) Foreign Application Priority Data
Jan. 29, 2015 (DE) 102015101332.0

(51) Int. Cl. F24C 15/10; B23K 26/362; G02B 27/42; B23K 26/064; G02B 5/18; C03C 23/00; B23K 26/40

(52) U.S. Cl. CPC F24C 15/10; C03C 23/0025; B23K 26/362; B23K 26/40; B23K 26/064; G02B 5/1861; G02B 27/4244

(57) ABSTRACT

A glass ceramic is provided that has an upper surface, a lower surface, and a surface zone of at least 10 nm thickness that is substantially amorphous so that a content of crystalline phases in the surface zone is at most 20 vol %. The glass ceramic has at least one lateral pattern with periodic and/or quasi-periodic features with a mean feature spacing of not more than 200 μm. The features are defined by depressions in the material of the surface zone so that the pattern as a whole does not protrude beyond the surface level. The features have a depth that is smaller than a thickness of the surface zone and do not extend into the region of the glass ceramic that has a higher content of crystalline phases.

### FIELD OF THE INVENTION

The invention relates to a glass ceramic with a specially designed surface and to a method for producing such a glass ceramic.

### BACKGROUND OF THE INVENTION

Glass ceramics are nowadays used in numerous applications. Because of its potential zero expansion and high thermal, mechanical, and chemical resistance, glass ceramics find application in particular in the semiconductor industry in steppers and exposure devices, in astronomy as a mirror carrier, and in the home appliance market as fireplace windows or for cooktops.

Glass ceramic cooktops have been known in the market for a long time, e.g. CERAN® cooktops of SCHOTT AG.

In order to be suitable as a cooktop, a glass ceramic must meet a number of requirements. For example, a low thermal expansion coefficient (α<0.5*10⁻⁶K⁻¹, 20-700° C.), low thermal conductivity (k<2.4 W/(m*K), and high temperature difference resistance are necessary to prevent failure of a cooktop due to breakage caused by the high temperature differences that occur between heated areas and non-heated areas of the cooktop. In terms of fracture strength, a glass ceramic has to meet stringent requirements as well, fracture strength herein referring to the resistance of the glass ceramic to loads from above, for example by a pot that is rudely placed on the surface.

For example, DE 10 2005 040 588 B4 describes the requirements consequently arising for a glazing on a glass ceramic cooktop. Generally, the expansion coefficients of a substrate and of a coating applied thereto, such as a glazing, should be matched in order to avoid stresses between the substrate and the glazing and resulting cracks and flaking. If this is not possible, as is the case for a glass ceramic suitable to be used as a cooktop, because the expansion coefficient of the glass ceramic is close to zero in the relevant temperature range, the coating should be applied as thin as possible. However, such a thin coating of an ink leads to a less intense color appearance.

Besides the high requirements that are imposed on both the strength of the glass ceramic and on the mechanical and chemical resistance of markings applied thereon, additional features have been increasingly demanded for cooktops or glass ceramics in the recent years, which are intended to enhance user experience when operating a cooktop. These include in particular surfaces with better cleanability, reduced visibility of, for example, fingerprints on the cooktop, or suppression of disturbing reflections. For all of these issues, different solutions have been proposed, for example in the form of surface treatments or coatings.

For example, a rough surface may be produced by an etching process. Etching of a glass surface is mostly accomplished by wet-chemical methods using hydrofluoric acid and thus is a process that presents considerable safety risks. Moreover, lateral patterning of the surface is not possible in this manner, since etching uniformly attacks the whole surface. As such, it is not a selective patterning method (anisotropic etch process), but a homogeneous patterning method which does not produce sharp edges. Anisotropic etching such as ion beam etching is technologically very complex because a vacuum is required, and is therefore very expensive.

Another option for patterning the surface of a glass is to introduce patterns directly after the hot forming process using a roller. However, it is not possible in this way to produce laterally patterned areas, rather the entire surface of the glass ribbon is uniformly provided with a pattern.

Furthermore, rolling methods are not capable of providing defined nanofeatures in glasses and glass ceramics, because due to the high processing temperature and the surface tension associated therewith any features will become rounded.

The preparation of haptic layers on a substrate is furthermore known from DE 20 2009 000 139 U1. The haptic patterns created in this example are produced by machining such as milling.

EP 1 876 394 A2 describes the preparation of haptic layers by a printing process, preferably by multiple printing. Multiple printing is technologically very complicated and therefore very expensive.

WO 01/74739 A1 describes the preparation of a self-cleaning surface by applying a texture with microroughness, in which the microrough texture has feature heights of >0.1 μm. In order to provide optimum self-cleaning properties, usually hydrophobization of the surface is achieved in a further step by applying alkyl and/or fluoroalkyl silanes. Although the latter can be fired at up to 500° C., they do not exhibit long-term thermal stability at temperatures above 300° C.

Furthermore, a coating with low surface energy is known from WO 2012/062467 A1, which is stable at high temperatures and scratch resistant and therefore seems to be suitable for use on a cooktop. However, for this purpose the layer has to be precisely adjusted in terms of crystal phases, layer thickness, porosity, and chemical composition.

DE 199 18 811 A1 discloses an example of a broadband antireflective layer on glass. The layer is porous in this example. Although measures are taken to improve abrasion and wipe resistance of the layer, the abrasion resistance achieved thereby is not appropriate for very high mechanical stress such as occurring, for example, when a cooktop is cleaned.

All the above solutions have in common that they have a number of serious drawbacks. Usually, the proposed coatings are not sufficiently scratch-resistant for withstanding conventional cleaning processes for cooktops, for example by means of a scraper for removing burnt residues, and/or they are not sufficiently heat resistant, especially in the hot area of the cooktop, i.e. in the actual cooking zones. Moreover, damage to the layers, for example due to excessive mechanical or thermal stress, is usually visible and annoying. If the functional layers are intended to be applied only locally, i.e. laterally patterned, expensive and technically still not sufficiently manageable patterning processes are required. Finally, difficulties arise with the integration of such coatings into the production process, since full-surface coating of a cooktop with a functional layer usually has to be performed after steps with high thermal load such as ceramization and possible subsequent firing of a decoration, which is also called secondary firing. Thereby, however, the issue of coating the marking itself arises, which will often lead to coating failure resulting from poor adhesion at these sites.

Another bothersome fact is that whichever effect is to be created, a different method has to be used. For instance in order to produce a surface that comprises areas with enhanced cleanability, areas with colored marking of cooking zones, areas with reduced surface reflection, and areas with haptic properties, it may be necessary to employ four different processes. This is an immense complexity and is difficult to implement for economic reasons.

Therefore, there is a need for a cost-efficient method for providing laterally patterned regions with markings and/or other functional properties such as enhanced cleanability or reduced reflectivity and with high thermal and mechanical resistance without impairing the overall strength on the upper surface of a glass ceramic or a cooktop made of a glass ceramic.

### OBJECT OF THE INVENTION

An object of the invention is to provide a glass ceramic that has laterally patterned functional areas on at least one surface thereof, and to provide a method for producing a glass ceramic with laterally patterned functional areas on at least one surface thereof.

### SUMMARY OF THE INVENTION

The object of the invention is achieved by a glass ceramic, a glass ceramic product such as a glass ceramic cooktop, and a method for producing an inventive glass ceramic or glass ceramic cooktop according to the independent claims. Refinements of the invention and advantageous embodiments are specified in the respective dependent claims.

The object of the invention is achieved surprisingly easily by a glass ceramic in which at least one surface of the glass ceramic has at least one laterally patterned region comprising periodic and/or quasi-periodic features with a mean feature spacing of 200 μm or less, for example in form of micro- and/or nanofeatures. Furthermore, the object is achieved by a glass ceramic in which at least one surface of the glass ceramic has at least one laterally patterned region comprising structures in the form of lines and/or areas.

In the context of the present invention, a region is referred to as being laterally patterned if it has a specific spatially well-defined extension on the at least one surface of the glass ceramic and adjoins other regions that have a different surface pattern. These other regions may in particular correspond to the initial glass ceramic, may be provided with a conventional decorative ceramic ink, or may also have nanopatterns, but of a different nature than those of the first region.

A glass ceramic is usually produced by a heat treatment (ceramization) of a suitable initial glass, the so-called green glass. Glass ceramics according to the invention are not limited to the examples mentioned below, which represent particularly preferred glass ceramic compositions with contents given in percent by weight (wt %).
(1) Lithium aluminosilicate glass ceramics (LAS)

| | |
|---|---|
| Al₂O₃ | 18-25% |
| SiO₂ | 50-72% |
| Li₂O | 0.1-10.0% |
| K₂O | 0-3% |
| Na₂O | 0-3% |
| MgO | 0-3% |
| P₂O₅ | 0-1% |
| SnO₂ | 0-1% |
| TiO₂ | 1.0-5% |
| ZrO₂ | 0.5-3.0% |
| ZnO | 0-5% |

(2) Lithium silicate glass ceramics (Li disilicate, metasilicate)

| | |
|---|---|
| Al₂O₃ | 2-25% |
| SiO₂ | 60-85% |
| Li₂O | 5-15% |
| K₂O + Na₂O | 0-8% |

(3) Magnesium/zinc aluminosilicate glass ceramics (MAS)
(4) Magnesium silicate glass ceramics
(5) Sodium/potassium aluminosilicate glass ceramics (NaAS, KAS)

The glass ceramic of the present invention preferably has a surface zone of at least 10 nm thickness which is substantially amorphous. In the context of the present invention, the substantially amorphous nature of the surface zone means that the surface zone does not contain more than 20 vol % of crystalline phases. Optionally, such a glassy surface zone may be provided only on one of the surfaces, or one of the surface zones may have a lower thickness than the 10 nm mentioned above.

Without being limited to the illustrated example, lithium aluminosilicate glass ceramics are particularly suitable for the invention. With this type of glass ceramic it is readily possible to produce a glassy surface zone with a small content of crystalline phases of not more than 20 percent by volume during ceramization of the starting glass, which typically causes lithium depletion in the surface zone.

Therefore, in this type of glass ceramic, the surface zone 8 is distinguished by a lower lithium content compared to the inner glass ceramic material 10.

The glass ceramic may be a plate, a 3D shaped body and/or a plate having recesses or indentations, for example in the form of depressions.

In the context of the present invention, micropatterns refer to patterns comprising features of a feature size smaller than 200 μm. Nanopatterns in the context of the present invention refer to patterns comprising features of a feature size smaller than 1 μm.

The micro- and/or nanofeatures preferably have a feature depth of 500 nm or less.

Feature size, in the present invention, refers to the mean spacing of the features.

In a further embodiment of the invention, the features have a spacing of less than 0.8 μm, preferably less than 500 nm, and more preferably between 1 nm and 400 nm.

Particularly preferably the features are formed as nanofeatures.

In particular, the feature depth of the micro- and/or nanofeatures in the laterally patterned surface regions of the at least one surface of the glass ceramic is such that the patterns are located within the substantially amorphous surface zone of the glass ceramic. Thus, the micro- and/or nanofeatures do not project into regions of the glass ceramic in which the content of crystalline phases is greater than 20 vol %. In this manner, very fine patterns are possible, which are not disturbed by the presence of crystals which would otherwise in particular alter the precision of edges and increase surface roughness. Another advantage of this embodiment is that in this manner, despite of the presence of laterally patterned surface regions which comprise periodic and/or quasi-periodic features with a mean feature spacing of not more than 200 μm, for example in the form of micro- and/or nanofeatures, the substantially amorphous surface zone of the glass ceramic is not disturbed, so that the glass ceramic retains its overall strength.

The surface regions of the glass ceramic according to the invention which comprise laterally patterned periodic and/or quasi-periodic features with a mean feature spacing of not more than 200 μm are designed as functional surfaces. They exhibit a color appearance or optical filter properties and/or improved cleanability and/or antireflective properties and/or haptic properties.

If on at least one side of a glass ceramic, fields that comprise regions exhibiting a color appearance and/or matting are to be produced according to the present invention, this is accomplished by forming special nanopatterned or micropatterned regions. Coating of the glass ceramic or of a corresponding green glass with a ceramic ink and subsequent firing of the ink is no longer necessary. If such regions exhibiting a color appearance and/or matting are produced on a glass ceramic using the methods provided by the present invention, no further material and no further process, in particular no further coating process will be needed to produce the functionality.

This also applies if effects other than coloring or matting effects are to be created in the laterally patterned regions. Again, the chemical and temperature resistance of the initial material will be preserved after treatment. The macroscopic effects are produced alone by nanopatterning in the laterally patterned regions.

In order to create a color appearance, grating patterns are produced in the laterally patterned regions of the surface of a glass ceramic by the method provided in the present invention. If grating patterns are produced with a period of the grating patterns, Λ, similar to the wavelength of light, λ, only a specific color is reflected in the first order.

Other orders will not exist since the diffraction angle is now >90°. The zeroth order is suppressed. A prerequisite for the aforementioned are specific feature depths.

Surprisingly, it has been found that in contrast to the optimum depth D for reflection gratings as published in textbooks (e.g. “Microoptics”, Sinzinger and Jahns, page 138ff.) different values are obtained for optimal results in the patterning of the glass ceramic. According to literature, the following applies for the optimum depth D of a reflection pattern:

$${D}_{lit} = \frac{λ}{4} \cdot ( n - 1 ) , \qquad ( 1 )$$

wherein λ is the wavelength of the light and n is the refractive index of the glass ceramic material. However, surprisingly, for the reflection gratings to be produced in a glass ceramic, the following relationship has been found between the theoretically calculated depth Dₗᵢₜ and the experimentally obtained optimum depth D_{GC} of the patterns:

D_{GC}=k·Dₗᵢₜ, (2)

wherein k denotes a correction factor. Correction factor k by means of which the actual optimum depth D_{GC} for the glass ceramic is derived from the theoretically calculated depth Dₗᵢₜ, is between 0.5 and 0.9, but mostly about 0.66.

Usually, a mosaic-like array of small areas is produced in this way, which due to a special nanopattern will produce a color impression for the viewer. Surprisingly, this color impression is largely independent of the angle. Largely independent in this context means that in an angular range between −30° and 30° the reflected intensity changes by less than 20%.

If a combination of many of these fields is created in a sort of mosaic, this allows to produce many colors in the RGB color space. Preferably, the lateral dimension of these small color areas should be less than the resolution limit of the eye, i.e. less than 20 μm. However, it is also possible to realize a large field with a special color appearance. The geometry is not necessarily limited to rectangles, but may as well represent images, shapes, or text. According to one embodiment of the invention, therefore, a lateral pattern is provided which comprises a plurality of regions or fields with different optical gratings.

If the period Λ of the grating is many times larger than the wavelength of light, λ, several orders will be reflected and a so-called rainbow spectrum will be obtained.

Similarly to a color appearance, it is likewise possible according to the present invention to achieve enhanced cleanability of the surface of a glass ceramic in an appropriately patterned surface region.

This is advantageously accomplished by introducing nanopatterns into the surface of the glass ceramic. In this manner the well-known effect of superhydrophobicity is achieved, sometimes called “lotus effect”. Due to the nanotexture of the relevant surface, in nature for instance that of a lotus plant leaf, there will only be very little contact between the surface and the water, namely only at the “peaks of the texture”. Water droplets will therefore retain their spherical shape, so that the adhesive forces between the water and the surface are reduced to a minimum. Dirt particles likewise will hardly adhere, because the contact area between the dirt particle and the surface is minimized in this case as well. Rolling water can thus easily entrain the dirt particles, so that all in all a surface equipped in this manner will exhibit significantly enhanced cleanability.

A contact or wetting angle usually serves to characterize the surface and in particular to determine hydrophobicity or hydrophilicity thereof. For a superhydrophobic surface, a contact angle of greater than 120° is obtained. This quantity may for instance be measured with a goniometer. The determination is made visually by looking at the droplet from the side. Below, FIG. 9 of the present invention illustrates droplets with different contact angles on a surface.

Furthermore, surfaces with reduced reflection are also easily produced according to the invention. This is again accomplished by introducing nanopatterns into the surface, and inspired by the surface pattern of insects eyes such a micropattern is also referred to as “moth eye pattern”. These patterns resemble a periodic hexagonal surface relief grating, they are arranged as a 2D grating and have a pattern repetition period of about 230 nm. If the pattern period is smaller than the wavelength of light, only the zeroth order of diffraction can propagate in reflection and transmission and the light passes through the patterned surface like through a plane interface, which means that the region can be considered as optically homogeneous and can be described with a homogeneous effective refraction index.

Furthermore, a glass ceramic according to the invention may also have lateral patterns that are characterized by haptic properties. Haptic properties are properties that are perceived by touching them.

According to a further embodiment of the invention, the laterally patterned regions comprising periodic and/or quasi-periodic features with a mean feature spacing of not more than 200 μm are not only produced in the surface of the glass ceramic itself, but may also be produced in regions which have a different composition than the glass ceramic. This may for instance be the surface of a ceramic ink into which a micropattern and/or nanopattern is introduced using the method of the invention.

Advantageously, such patterning of a decorative ink may be combined with simultaneous firing of the ceramic ink, that means, firing of the ceramic ink is accomplished during the patterning of the surface by the patterning process itself.

With this combination of surface patterning and firing of the ink, the power output parameters for exposure have to be thoroughly considered. Conveniently, exposure is accomplished using a laser with spatially varying intensity of the laser spot. This so-called beam shaping is effected in such a manner that the energy density in the peripheral zone of the laser beam is lower than in the center thereof, so that the intensity distribution of the laser beam is spatially resolved. The intensity distribution may comprise one or more spatially resolved levels or may follow a complicated pattern which may for instance be predefined by a diffractive optical element (DOE).

Such beam shaping is required whenever it is necessary to initially achieve milder heating of the region to be patterned, for example when firing of inorganic inks is to be achieved. Such inorganic or ceramic inks typically comprise a glass flux, i.e. particles which melt at relatively low temperatures, and high-temperature stable, usually coloring particles, the pigments. Upon melting of the glass flux due to energy input, the glass flux encloses the coloring non-melted particles and bonds to the substrate. If during this time the energy input is excessively high, it may happen that a so-called melt reaction zone forms in which flaking may be caused. To avoid this, the intensity of the laser beam or, more generally, of the exposure beam should be selectively adjusted with spatial resolution when using the method of the invention.

A ramp-shaped intensity distribution is particularly favorable.

The glass ceramics of the present invention have thermally and chemically resistant patterns. In this way, glass ceramics with individual authentication features are provided according to one embodiment of the invention. These may be logos, for example, as well as other patterns.

According to the present invention, the laterally patterned surface regions on a glass ceramic, for instance on a glass ceramic cooktop, are produced by exposure of the glass ceramic surface.

According to one embodiment of the invention, the exposure of the ceramic glass surface for producing a laterally patterned surface region is accomplished using a laser.

According to one embodiment of the invention, the surface treatment is accomplished using non-coherent, monochromatic light.

Particularly preferably, patterning of the surface is accomplished using a UV picosecond laser.

According to a further embodiment of the invention, surface treatment is performed with white light, for example by using a flash lamp and/or an LED lamp.

In one embodiment of the invention, the laterally patterned surface regions are formed by laser-generated ablation of the glass ceramic at the locations exposed to the laser light according to a predetermined pattern.

Accordingly, the inventive method for producing a glass ceramic which has at least one surface provided with lateral patterns comprising periodic and/or quasi-periodic features with a mean feature spacing of not more than 200 μm comprises at least the steps of:
defining a predetermined pattern of surface areas to be exposed and not to be exposed for producing periodic and/or quasi-periodic features with a mean feature spacing of not more than 200 μm;
providing a glass ceramic;
providing a light source;
treating a surface of the glass ceramic so that the areas to be exposed according to the predetermined pattern are exposed.

If a specific pattern is to be produced on a glass ceramic, it may for example be predefined by a so-called diffractive optical element (DOE). It is also possible to have this pattern generated directly by a computer so that it is not provided in the form of a DOE but as an “electric hologram”. In this manner, ablation or firing is caused in the exposed areas. The information about the pattern to be produced is intrinsically contained in the DOE in the form of a computer-generated hologram. Whether the pattern is introduced into the surface by firing or by ablation will depend on the specific embodiment of the process, that means whether the pattern is to be introduced directly into the surface of the glass ceramic or into a ceramic ink.

The use of a DOE is especially advantageous, because in this manner the number of exposures is significantly reduced and the scanning process is shortened or even entirely eliminated in certain cases. This reduces the entire manufacturing process. Furthermore, this permits to rather easily realize nanopatterns on 3D geometries.

In the context of the present invention, ablation refers to the removal of material from a surface by impinging radiation. Laser ablation or laser vaporization accordingly refers to the removal of material from a surface by impinging laser radiation. Generally, laser radiation is preferred for such a method, since laser radiation exhibits high power density.

Depending on the pulse width and wavelength, the following power densities are typically achieved with commercially available lasers during laser ablation:

femtosecond laser >10¹² W/cm²;
picosecond laser >10¹² W/cm²;
nanosecond laser >10⁹ W/cm²;
microsecond laser >10⁹ W/cm².

If firing of a ceramic ink is intended to be accomplished by laser radiation, laser power is lower than for ablation. For best results of laser firing it is necessary that the laser power is well and homogeneously absorbed by the material to be melted, in the present case the ceramic ink.

The following types of lasers are suitable, in principle, for such processes:
(a) solid-state lasers (ceramic, glass, or crystal rod or disk lasers, e.g. Ti:Al₂O₃ lasers, Nd:YAG lasers, Yb:YAG lasers);
(b) fiber lasers (e.g. Er:glass lasers);
(c) semiconductor lasers (e.g. GaAs lasers, InGaAs lasers);
(d) gas lasers (e.g. XeF or argon lasers).

### EXEMPLARY EMBODIMENTS

### Exemplary Embodiment 1

For firing a ceramic ink to produce a laterally patterned surface region comprising periodic and/or quasi-periodic features with a mean feature spacing of not more than 200 μm, for example in the form of micro- and/or nanofeatures, a laser of a wavelength of 1064 nm is used. The laser is operated in pulsed mode with a pulse width of 10 nanoseconds and at a frequency of 5 kHz. The laser power density obtained is about 40 W/cm².

### Exemplary Embodiment 2

For firing a ceramic ink, a laser of a wavelength of 980 nm is used. It is operated in CW mode with an exposure time of 10 seconds. Laser power density is about 83 W/cm².

### BRIEF DESCRIPTION OF THE DRAWINGS

FIG. 1 schematically shows a glass ceramic according to the invention with laterally patterned regions comprising periodic and/or quasi-periodic features with a mean feature spacing of not more than 200 μm.

FIG. 2 shows an apparatus for generating a light concentrator or light distributor.

FIG. 3 shows two reflection spectra of a lateral pattern in a glass ceramic surface, the pattern comprising periodic and/or quasi-periodic features with a mean feature spacing of not more than 200 μm, for example in the form of micro- and/or nanofeatures.

FIG. 4 shows two reflection spectra of another lateral pattern in a glass ceramic surface, the pattern comprising periodic and/or quasi-periodic features with a mean feature spacing of not more than 200 μm, for example in the form of micro- and/or nanofeatures.

FIG. 5 shows two reflection spectra of a further lateral pattern in a glass ceramic surface, the pattern comprising periodic and/or quasi-periodic features with a mean feature spacing of not more than 200 μm, for example in the form of micro- and/or nanofeatures.

FIG. 6 shows two reflection spectra of a further lateral pattern in a glass ceramic surface, the pattern comprising periodic and/or quasi-periodic features with a mean feature spacing of not more than 200 μm, for example in the form of micro- and/or nanofeatures.

FIG. 7 schematically shows a glass ceramic according to the invention with laterally patterned regions within several depressions which comprise periodic and/or quasi-periodic features with a mean feature spacing of not more than 200 μm, for example in the form of micro- and/or nanofeatures.

FIG. 8 schematically shows a wok-shaped glass ceramic according to the invention having a laterally patterned region in a depression which comprises periodic and/or quasi-periodic features with a mean feature spacing of not more than 200 μm, for example in the form of micro- and/or nanofeatures.

FIG. 9 schematically illustrates different contact angles of droplets on a surface.

FIG. 10 schematically illustrates a grating pattern in a surface.

### DETAILED DESCRIPTION OF THE DRAWINGS

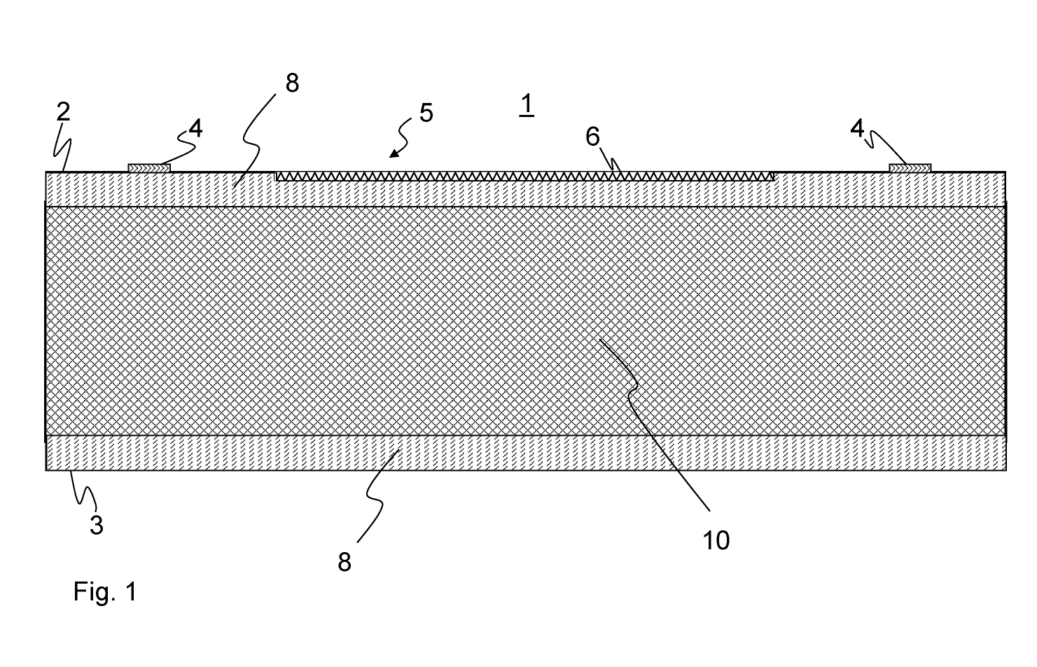

FIG. 1 schematically shows a glass ceramic 1 that has two surfaces, namely upper surface 2 and lower surface 3. Lower surface 3 of glass ceramic 1 is illustrated as smooth in FIG. 1, but may as well be knobbed.

Generally, without being limited to the specific exemplary embodiments illustrated in the figures, the invention provides a glass ceramic 1 as shown in FIG. 1 by way of example, which has an upper surface 2 and a lower surface 3 and a surface zone 8 of at least 10 nm thickness which is substantially amorphous, so that a content of crystalline phases in the surface zone is at most 20 vol %, and the glass ceramic 1 has at least one lateral pattern 5, which lateral pattern 5 comprises periodic and/or quasi-periodic features 6 with a mean feature spacing of not more than 200 μm, for example in the form of micro- and/or nanofeatures. These features are defined by recesses in the material of the surface zone 8. The lateral pattern 5 as a whole does not protrude beyond the surface level. The depth of lateral pattern 5 is smaller than the thickness of surface zone 8 and therefore does not extend into the region of the glass ceramic 1 that has a higher content of crystalline phases. The region with a higher content of crystalline phases constitutes the actual glass ceramic material 10. A glass ceramic with a content of crystalline phases of at least 30% is considered to be such a material. In case of the lithium aluminosilicate glass ceramic which is preferably used, the lithium content of the surface zone 8 is typically lower than that in the inner glass ceramic material 10. Features are also considered to be periodic micro- and/or nanofeatures if together they act as a diffractive optical element. While they do not necessarily need to exhibit strict periodicity, such elements are typically composed of repeating features.

Therefore, according to one embodiment of the invention a lateral pattern comprising periodic and/or quasi-periodic features 6 with a mean feature spacing of not more than 200 μm, for example in the form of micro- and/or nanofeatures which act as a diffractive optical element (DOE) is introduced into the surface zone 8. With such diffractive optical elements it is for example possible to create logos which become visible by illumination and projection. In particular, such a diffractive optical element may be a so-called computer-generated hologram. DOEs can be calculated according to the IFTA algorithm, for example. The so calculated pattern is subsequently introduced into the glassy surface zone 8 by laser ablation.

The upper surface 2 further includes regions in which a coating 4 has been applied. Such coatings 4 may represent cooking zone markings, for example of a circular shape, and may comprise a ceramic ink. In the example shown in FIG. 1 it is the upper surface 2 of ceramic glass 1 which has a laterally patterned region 5 comprising periodic and/or quasi-periodic features 6 with a mean feature spacing of not more than 200 μm, for example in the form of micro- and/or nanofeatures. For the sake of better understanding, the illustrated features are not correctly drawn to scale. For example, the thickness of a cooking zone marking, here exemplified by coatings 4, is usually in the micrometer range, whereas features 6 have features depths of less than one micrometer; the glass ceramic typically has a thickness from 2 to 6 mm. As illustrated, the depth of lateral pattern 5 comprising periodic features 6 is smaller than the thickness of the glassy surface zone 8. As already explained above, lateral pattern 5 with features 6 in the form of recesses is formed by laser ablation. The invention has particular advantages over other methods for producing markings or patterns in the surface of glass ceramics. If a nanopattern is introduced into a glass ceramic material that has a content of crystalline phases in a usual amount (typically more than 50 percent by volume), the problem is that the crystallites interfere with the intended shape of the nanopattern features, in particular because the crystallites have a size that is at least partly in the order of the feature size of the features or even larger. Therefore, the features will have an inaccurate shape, since the ablation rate is influenced by the shape and location of the crystallites.

In order to ensure that the recesses do not protrude through the glassy surface zone 8 into the inner glass ceramic material 10, a preferred feature depth for features 6 is 500 nm or less.

Now, a variety of effects can be achieved with the periodically arranged features 6. Features 6 may in particular be used to cause a specific color appearance or to act as a color filter. Such color effects may be achieved because the lateral pattern functions as a grating, or, more generally, as a diffractive optical element.

It is also possible to achieve an antireflective effect corresponding to a so-called moth-eye effect. For this purpose, the feature size of features 6 is preferably chosen to be smaller than the relevant wavelengths of the visible spectral range. Optionally, it is also possible to achieve enhanced cleanability of the surface. Furthermore, haptic properties may be imparted to the patterned surface areas, because despite the small depth of features 6, they will usually be perceptible by touch.

To achieve the aforementioned effects, in particular to obtain interference effects with visible light, it is favorable if the mean feature spacing of features 6 is 1000 nm or less, preferably 500 nm or less, and most preferably between 1 and 400 nm.

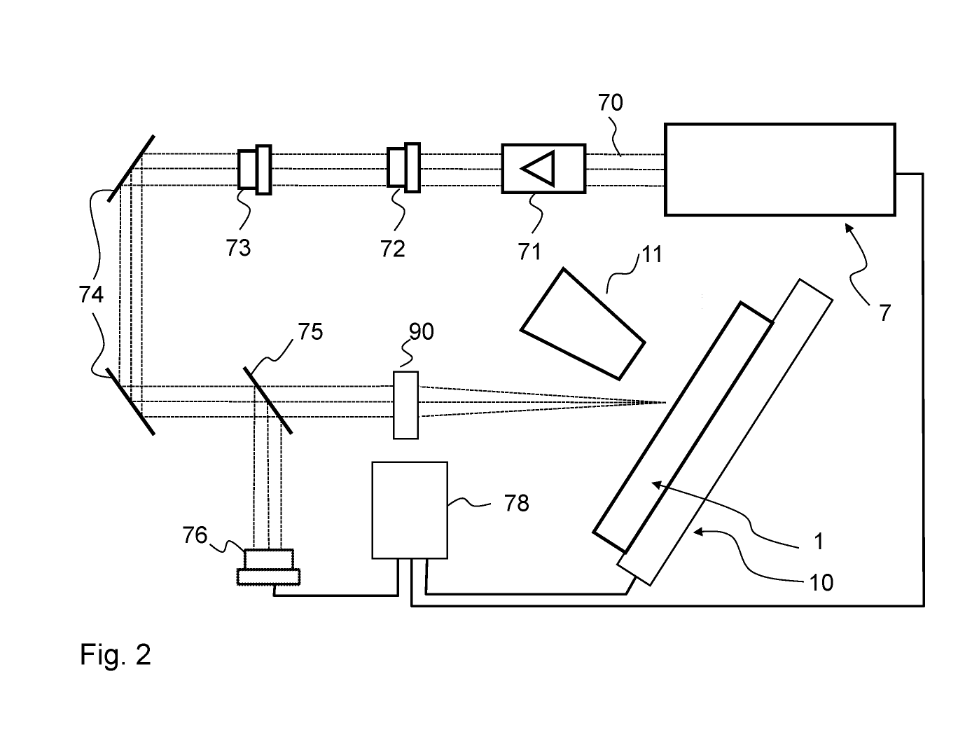

FIG. 2 schematically illustrates an apparatus for generating a light concentrator or light distributor, by means of which a lateral pattern as envisaged by the invention can be prepared by ablation. A laser 7, for example a neodymium-garnet laser (Nd:YAG laser) which can be operated in a frequency-tripled mode at a wavelength of 354.6 nm with a pulse width of one picosecond (ps), emits radiation 70 via an optical diode 71, a λ/2 plate 72, and a polarizer 73, and optionally via a deflection system 74, to a beam splitter 75 which deflects a small fraction of the power to a power meter 76 and supplies a larger fraction of the power to a focusing element 90. The laser radiation is focused onto or into a glass ceramic 1, which glass ceramic may have a coating thereon, in the form of a ceramic ink. Glass ceramic 1 as a workpiece is placed on a workpiece holder 9. Workpiece holder 9 can be finely adjusted in the x, y, and z directions relative to a microscope objective lens 11. 3D piezoelectric actuator motors with precision bearings and linear guides may be used for this purpose. An interferometric measuring device is used. Such shifting means are capable of achieving repeatability of better than 2 nm. A control device 78 is coupled to laser 7, power meter 76, and workpiece holder 9, to control and adjust the processing flow during processing of glass ceramic 1. Other lasers with a pulse width of less than one picosecond and with a wavelength in a range from 180 to 2000 nm may be used as well.

As explained above, the invention provides the advantage that the restriction of ablation to the glassy surface zone 8 provides for well-defined geometries of features 6 on the one hand, and on the other has a lower impact on the strength compared to ablation in the inner glass ceramic material. These effects can be supported by further measures. One possibility is laser ablation at a higher substrate temperature. Preferably, according to this embodiment of the invention, the glass ceramic is heated to at least 200° C., and laser ablation can then be effected on the so heated glass ceramic 1.

As shown in the example of FIG. 2, the laser beam 70 is obliquely irradiated to the surface of the glass ceramic 1. It has been found that the roughness of features 6 produced by ablation can be reduced by such an oblique irradiation. The reason for this is that the ablated material is mainly ejected perpendicularly to the surface. In case of vertical irradiation, this material might interfere with the laser beam 70.

It is furthermore favorable to choose the pulse repetition rate smaller than a cooling rate t(ΔT<5%). This cooling rate is the duration of a drop in temperature by 5% of the temperature difference between the temperature of the material heated by laser ablation and the initial temperature (i.e. room temperature or the temperature to which the glass ceramic was preheated).

Exemplary embodiments of lateral patterns in the form of optical gratings will now be explained below. Such optical gratings are defined by features 6 in the form of linear recesses running side by side, or by features with a periodicity in two spatial directions along the surface.

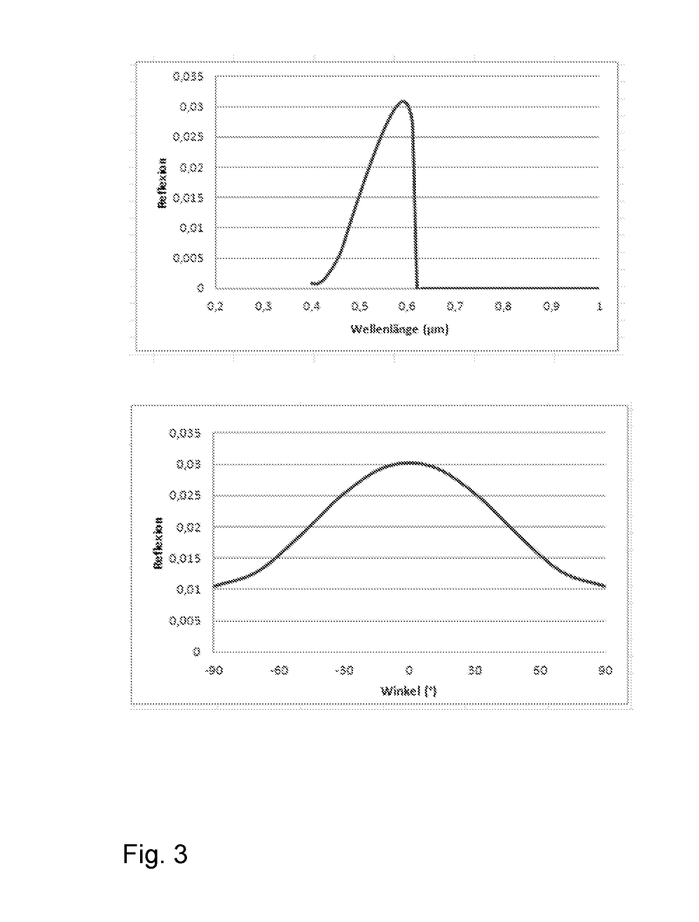

FIG. 3 shows, in the upper part, the calculated reflectance for a grating with a period of 0.62 μm and a depth D_{GC} of 0.2 μm as a function of wavelength. The color impression achieved with this grating is red. The theoretically optimal depth Dₗᵢₜ calculated according to equation (1) for a wavelength λ of 0.63 μm is 0.303 μm, so that according to equation (2) a correction factor k of 0.66 is obtained. In the lower part, FIG. 3 shows the calculated reflectance as a function of the viewing angle. As is clearly visible, highest reflectance is obtained for a viewing angle close to 0°, that is, for nearly perpendicular viewing. For a variation of the viewing range between −30° and 30°, reflectance only varies by less than 20%.

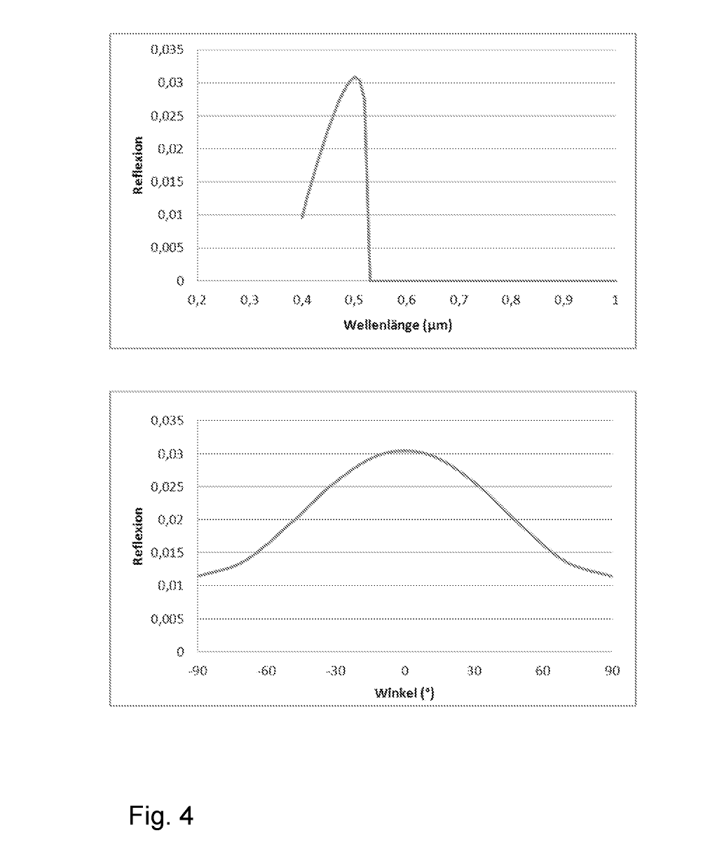

FIG. 4 shows, in the upper part, the calculated reflectance for a grating with a period of 0.53 μm and a depth D_{GC} of 0.165 μm as a function of wavelength. The color impression achieved with this grating is green. The theoretically optimal depth Dₗᵢₜ calculated according to equation (1) for a wavelength λ of 0.53 μm is 0.25 μm, so that according to equation (2) a correction factor k of 0.66 is obtained. In the lower part, FIG. 4 shows the calculated reflectance as a function of the viewing angle. As is clearly visible, highest reflectance is obtained for a viewing angle close to 0°, that is, for nearly perpendicular viewing. For a variation of the viewing range between −30° and 30°, reflectance only varies by less than 20%.

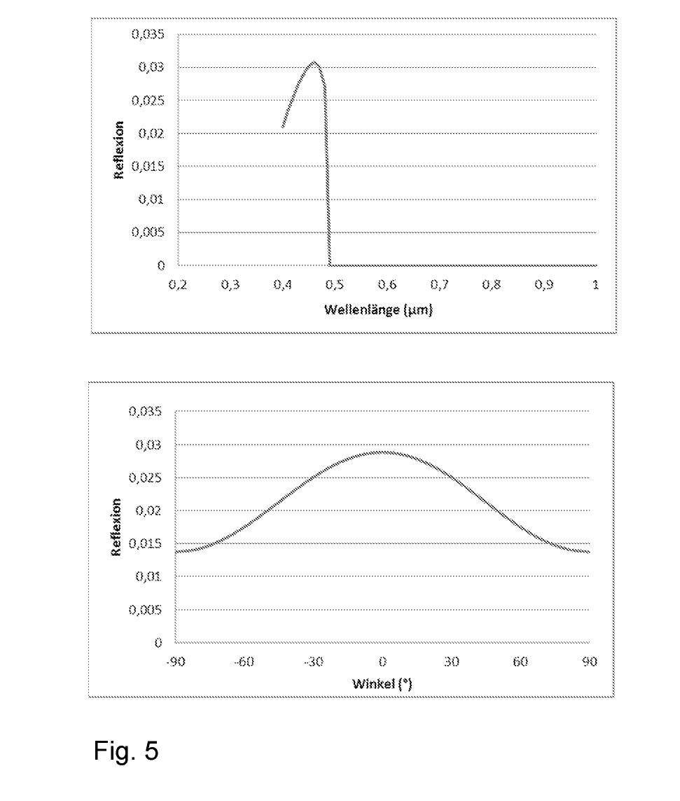

FIG. 5 shows, in the upper part, the calculated reflectance for a grating with a period of 0.49 μm and a depth D_{GC} of 0.145 μm as a function of wavelength. The color impression achieved with this grating is blue. The theoretically optimal depth Dₗᵢₜ calculated according to equation (1) for a wavelength λ of 0.53 μm is 0.226 μm, so that according to equation (2) a correction factor k of 0.64 is obtained. In the lower part, FIG. 5 shows the calculated reflectance as a function of the viewing angle. As is clearly visible, highest reflectance is obtained for a viewing angle close to 0°, that is, for nearly perpendicular viewing. For a variation of the viewing range between −30° and 30°, reflectance only varies by less than 20%.

According to one embodiment of the invention, a lateral pattern in the form of an optical grating is introduced into the surface zone, in which the periodic or quasi-periodic features 6 are recesses having a depth D_{GC} of

$${D}_{GC} = k \cdot \frac{λ}{4} \cdot ( n - 1 ) , \qquad ( 3 )$$

wherein λ is the wavelength of the light reflected with maximum intensity in the first diffraction order, and n is the refractive index of the material of the surface zone, and k is a factor in a range between 0.5 and 0.9, preferably between 0.6 and 0.8. Equation (3) results from a combination of equations (1) and (2) given before.

If now, within the laterally patterned region 5, a plurality of fields with different color impressions as caused by periodic and/or quasi-periodic features, e.g. in the form of micro- and/or nanofeatures created in a laterally patterned region 5 are combined, i.e. a plurality of fields with different optical gratings are combined, any desired color appearance can be produced by the resulting mix of colors.

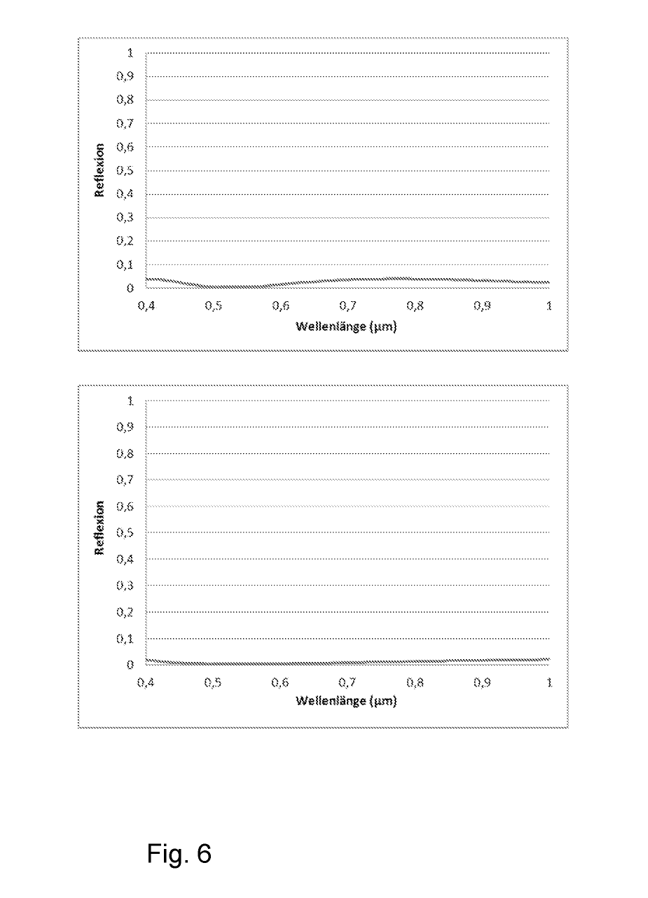

For illustrating the so-called “moth-eye effect”, FIG. 6 shows, in the upper part, a calculated reflectance spectrum for a wavelength λ of 0.5 μm for a grating with a period of 0.25 μm and a depth of 0.3 μm. Due to the nanopatterning of the surface in form of the grating, the obtained reflectance is very low. Also for illustrating the so-called “moth-eye effect”, the lower part of FIG. 6 shows a calculated reflectance spectrum for a grating with a period of 0.25 μm and a depth of 0.1 μm for a wavelength λ of 0.5 μm. Again, extremely low reflectance is achieved in this case.

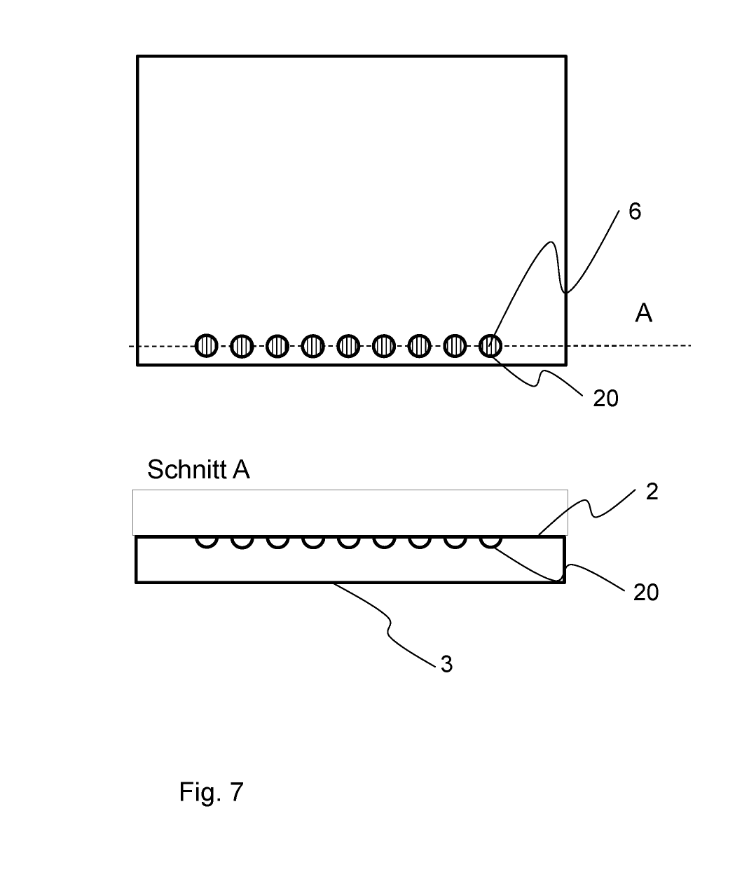

FIG. 7 schematically illustrates, in the upper part, a glass ceramic 1 having a plurality of laterally patterned regions 5, in the form of depressions 20 in this case. Laterally patterned regions 5 have not been denoted in this view, since they completely cover the areas of the upper surface 2 of glass ceramic 1 which take the form of depressions 20, that means, in this example regions 5 are identical to depressions 20. Furthermore, line A is indicated, along which the glass ceramic 1 was cut, the resulting section being shown in the lower part of FIG. 7. Here, depressions 20 include periodic and/or quasi-periodic features 6, for example in the form of a micropattern and/or nanopattern which was produced by laser ablation. Alternatively or additionally, depressions 20 may include ceramic inks covering the entire depression 20 or only a portion thereof, and in this case firing of the inks was accomplished using a laser. It is also possible that only a portion of the depressions is provided with periodic and/or quasi-periodic features 6. Furthermore, a light source and/or a sensor may be located below the depressions 20. The glass ceramic has two surfaces, upper surface 2 and lower surface 3. In FIG. 7, the lower surface 3 of glass ceramic 1 is shown as being smooth, but it may as well be knobbed. A laterally patterned region 5 formed in a depression 20 in this manner enhances user-friendliness of the cooktop by haptic assistance. If light sources are disposed below the depressions 20, they can be optimized by appropriately patterning the laterally patterned region 5 with periodic and/or quasi-periodic features 6 for focusing or defocusing the light, and in this manner user-friendliness of the cooktop can be further enhanced.

The lower part of FIG. 7 schematically shows a section along the cut line denoted by A, in particular for illustrating the shape of depressions 20. Thus, depressions 20 have a curved surface, i.e. they are not planar. In the present context, curvature refers to a curvature that has a radius of curvature of at least 1 mm or more.

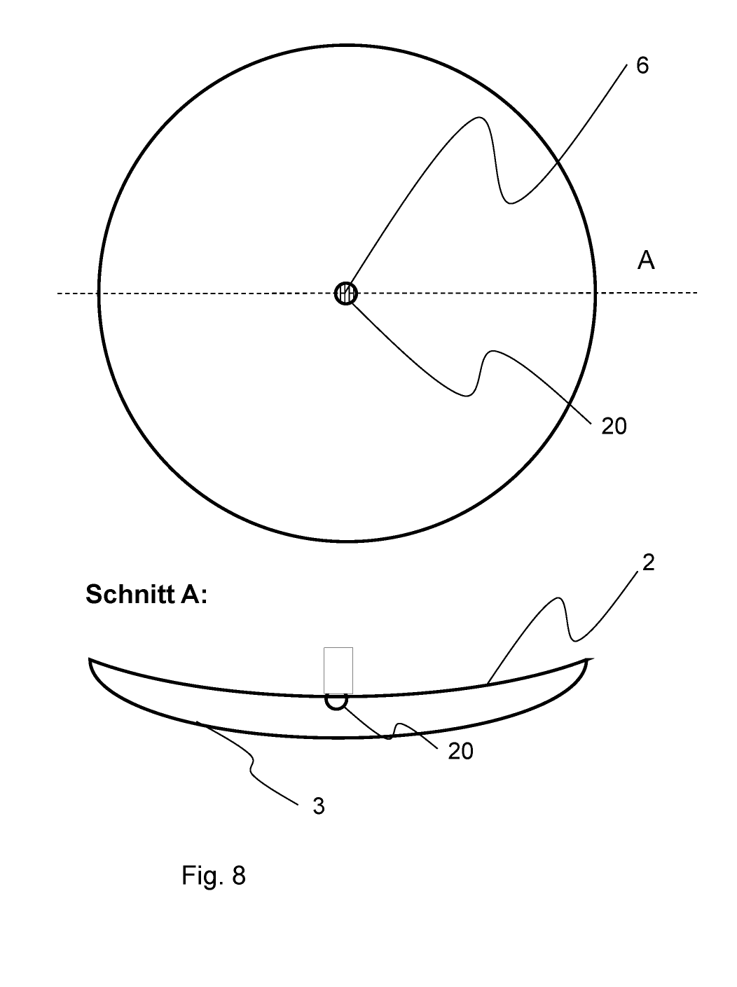

FIG. 8, in the upper part, schematically illustrates a wok glass ceramic 1 having a laterally patterned region 5 (not indicated), in the form of a depression 20 in this case. Laterally patterned region 5 has not been denoted in this view, since it completely covers the area of the upper surface 2 of glass ceramic 1 which takes the form of depression 20, that means, in this example the region 5 is identical to depression 20; and in the lower part, FIG. 8 illustrates a section through the glass ceramic 1 along cut line A as indicated in the upper part of FIG. 8. Here, depression 20 includes periodic and/or quasi-periodic features 6, for example in the form of a micropattern and/or nanopattern which was produced by laser ablation.

Alternatively or additionally, depression 20 may include ceramic inks, and in this case firing of the inks was accomplished using a laser. Moreover, a light source and/or a sensor may be located below depression 20. The glass ceramic 1 has two surfaces, upper surface 2 and lower surface 3. In FIG. 8, the lower surface 3 of glass ceramic 1 is shown as being smooth, but it may as well be knobbed. The section along line A illustrated in the lower part of FIG. 8 reveals the curved shape of the glass ceramic as a whole, that means, the glass ceramic is a 3D-shaped body in this case. Furthermore, the curved surface of the glass ceramic in the region of depression 20 can be seen. In the present context, curvature refers to a curvature which has a radius of curvature of at least 1 mm or more.

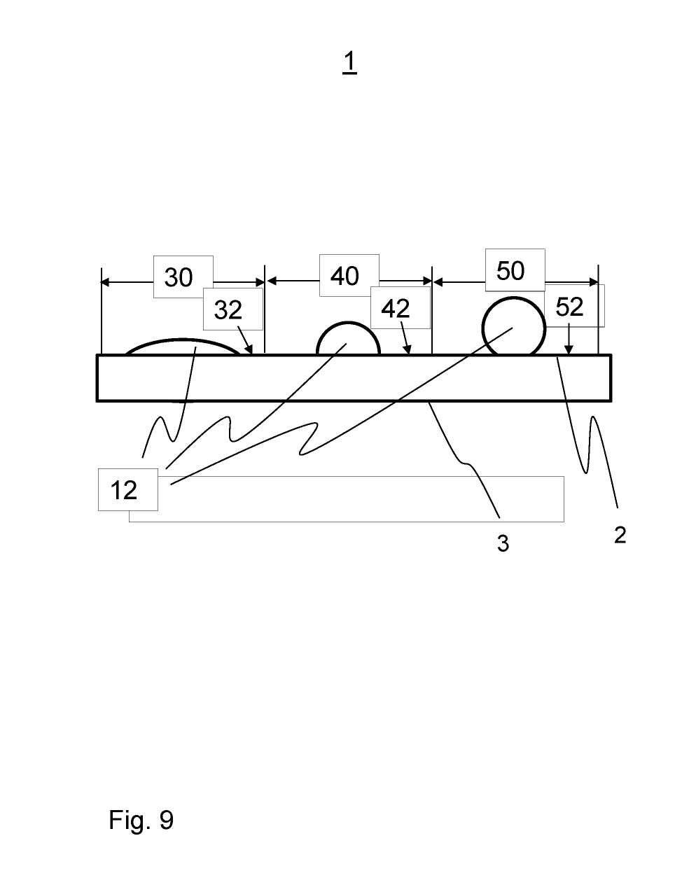

FIG. 9 schematically illustrates droplets 12 on the upper surface 2 of a glass ceramic 1 in different regions 30, 40, and 50 thereof. The lower surface 3 of glass ceramic 1 is shown as being smooth here, but it may as well be knobbed or otherwise textured.

In the left region 30 of glass ceramic 1, the contact angle of droplet 12 is less than 80° and droplet 12 spreads on the surface 32 of region 30. Such a surface 32 is referred to as hydrophilic and exhibits good wettability.

In the central region 40 of glass ceramic 1, a second droplet 12 is illustrated, which has a contact angle between 80° and 120° relative to the surface 42 of region 40. In this case, surface 42 is considered to have hydrophobic properties. This may for example be the case if surface 42 was provided with a silanization layer to become hydrophobic.

In the right region 50 of glass ceramic 1, a third droplet 12 is illustrated, which has a contact angle of 120° or more relative to the surface 52 of region 50. Thus, droplet 12 hardly wets the surface 52. Such a surface 52 is referred to as superhydrophobic. Such superhydrophobicity can be achieved by suitably patterning a surface, for example with periodic and/or quasi-periodic features 6 (not shown).

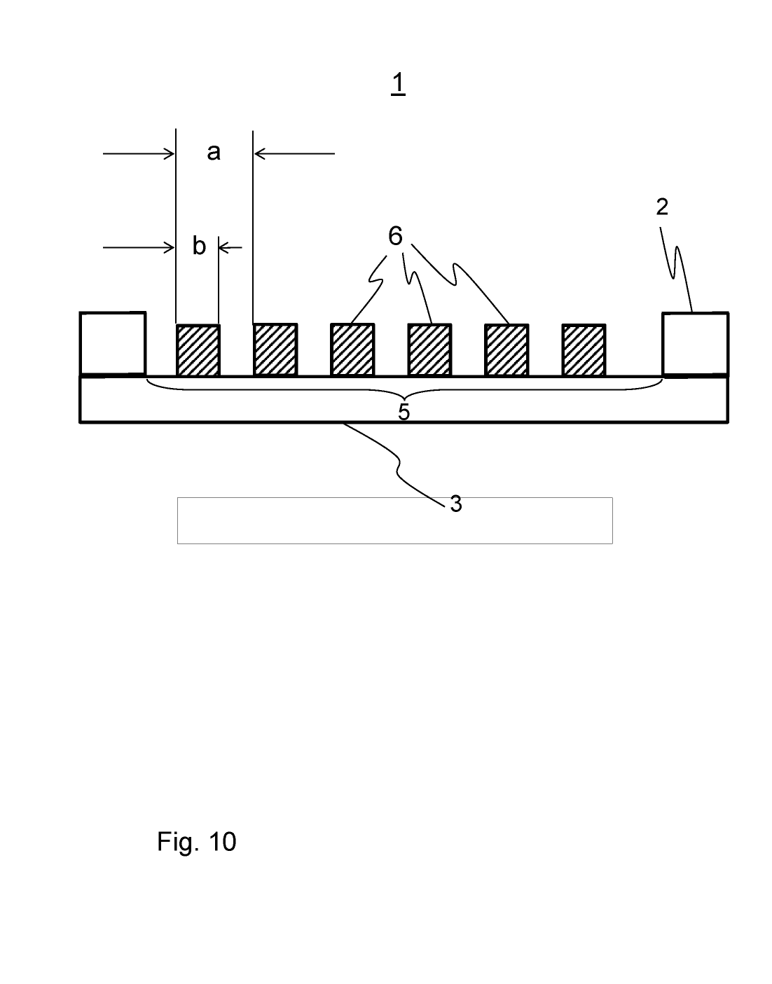

FIG. 10 schematically illustrates periodic and/or quasi-periodic features 6 in a laterally patterned region 5 of glass ceramic 1 provided on the upper surface 2 of the glass ceramic 1. The lower surface 3 of glass ceramic 1 is shown as being smooth here, but it may as well be knobbed. For better clarity, not every feature 6 has been denoted. Features 6 do not protrude beyond the initial surface level of the glass ceramic, rather they are located within the amorphous surface zone of the glass ceramic. Furthermore, they are defined by a period ‘a’ and a feature size ‘b’. The terms “pattern period”, “period of the features”, or “feature repetition pitch” are used synonymously in the context of the present invention, as is the case for terms “feature size”, “spacing of the features” and “feature spacing”. For producing superhydrophobicity, for example, 2D gratings with a ratio b:a from 0.4 to 0.6 are preferred. The ratio of feature size b to pattern period a is also referred to as duty cycle. Surprisingly, features having non-perpendicular edges, such as e.g. pyramidal, cylindrical and/or trapezoidal features with rounded edges are particularly suitable.

It will be apparent to those skilled in the art that generally, without limitation to the embodiments illustrated in the aforementioned figures, periodic and/or quasi-periodic features 6 such as nano- and/or micropatterns may not only be provided in depression-shaped recesses in certain laterally patterned regions 5. It is equally possible in this way to provide such features 6 in elevations.

### LIST OF REFERENCE NUMERALS

1 Glass ceramic
2 Upper surface of glass ceramic
3 Lower surface of glass ceramic
4 Coating
5 Laterally patterned region
6 Periodic and/or quasi-periodic features with a mean feature spacing of 200 μm
7 Laser
8 Surface zone
9 Workpiece holder
10 Inner glass ceramic material
11 Microscope objective lens
12 Droplet
20 Depression
30 Region of glass ceramic with hydrophilic surface
32 Surface of region 30 with hydrophilic properties
40 Region of glass ceramic with hydrophobic surface
42 Surface of region 40 with hydrophobic properties
50 Region of glass ceramic with superhydrophobic surface
52 Surface of region 50 with superhydrophobic properties
70 Radiation
71 Optical diode
72 λ/2 plate
73 Polarizer
74 Deflection system
75 Beam splitter
76 Power meter
78 Control device
90 Focusing optical element
A Cut line through a glass ceramic
a Pattern period
b Feature size

1-25. (canceled)

26. A glass ceramic comprising:
an upper surface;
a lower surface;
a surface zone at each of the upper and lower surfaces that have a thickness of at least 10 nm thick, the surface zone being substantially amorphous so that a content of crystalline phases in the surface zone is at most 20 vol %;
an inner region between the surface zone at the upper and lower surfaces, the inner region having a higher content of crystalline phases than the surface zones; and
a lateral pattern in the surface zone of at least one of the upper and/or lower surfaces, the lateral pattern comprising periodic and/or quasi-periodic features that have a mean feature spacing of not more than 200 μm, the features being defined by recesses in the surface zone, wherein the lateral pattern, as a whole, does not protrude beyond the upper and/or lower surface, and wherein the features have a depth that is smaller than the thickness of the surface zone and does not extend into the inner region.

27. The glass ceramic of claim 26, wherein the lateral pattern comprises a diffractive optical element.

28. The glass ceramic of claim 26, wherein the lateral pattern is defined in a depression on the upper or lower surface.

29. The glass ceramic of claim 26, wherein the glass ceramic is a lithium aluminosilicate glass ceramic and the surface zone) has a lithium content that is lower by at least 50% compared to that of the inner region.

30. The glass ceramic of claim 26, wherein the lateral pattern exhibits an angle-independent color appearance.

31. The glass ceramic of claim 26, wherein the lateral pattern exhibits a property selected from the group consisting of cleanability, antireflection, haptic, and any combinations thereof.

32. The glass ceramic of claim 26, wherein the features define an optical grating.

33. The glass ceramic of claim 26, wherein the features define a plurality of fields comprising different optical gratings.

34. The glass ceramic of claim 33, wherein the features have a depth DGC of
$${D}_{GC} = k \cdot \frac{λ}{4} \cdot ( n - 1 ) ,$$
wherein λ is a wavelength of light reflected with maximum intensity in a first diffraction order, and n is a refractive index of the surface zone, and k is a factor in a range between 0.5 and 0.9.

35. The glass ceramic of claim 26, wherein the features have a depth of 500 nm or less.

36. The glass ceramic of claim 26, wherein the mean feature spacing is 1000 nm or less.

37. The glass ceramic of claim 26, wherein the glass ceramic is configured for use as a glass ceramic cooktop.

38. A method for producing a glass ceramic, the comprising the steps of:
defining a predetermined pattern of surface areas to be exposed and not to be exposed to produce a surface pattern, the surface pattern comprising periodic and/or quasi-periodic features with a mean feature spacing of not more than 200 μm;
providing a glass ceramic having an upper surface and a lower surface;
providing a laser;
treating the upper surface of the glass ceramic with the laser so that the surface areas to be exposed according to the predetermined pattern are exposed.

39. The method of claim 38, wherein in the exposed areas, the laser ablates the glass ceramic to remove material.

40. The method of claim 38, further comprising heating the glass ceramic to at least 200° C. and treating the upper surface with the laser on the heated glass ceramic.

41. The method of claim 38, further comprising irradiating the glass ceramic with a laser beam of the laser obliquely to the upper surface.

42. The method of claim 38, wherein the surface areas to be exposed have a composition that is different from a composition of the glass ceramic.

43. The method of claim 42, wherein the surface areas comprise a ceramic ink.

44. The method of claim 43, wherein the exposure to the laser further comprises firing the ceramic ink.

45. The method of claim 38, wherein the laser comprises a picosecond UV laser.

46. The method of claim 38, further comprising spatially varying an intensity distribution of a beam of the laser.

47. The method of claim 46, wherein the intensity distribution has a ramp shape.

48. The method of claim 46, wherein the intensity distribution is predefined by a diffractive optical element or a computer.

49. The method of claim 46, wherein the intensity distribution is predefined by a diffractive optical element and exposure is effected in a stationary mode.
